(19) United States
(12) Patent Application Publication
(10) Pub. No.: US 2012/0096750 A1
(43) Pub. Date: Apr. 26, 2012

(54) ARTICULATING DOUBLE-SIDED GRAPHIC PANEL

(75) Inventors: James A. Wiemer, Fox Point, WI (US); Grant Squiers, Marshalltown, WI (US); Ryan Brobst, Grafton, WI (US); Lee Gettelfinger, Mequon, WI (US)

(73) Assignee: DCI Marketing, Inc. (a Wisconsin corporation), Milwaukee, WI (US)

(21) Appl. No.: 12/908,643

(22) Filed: Oct. 20, 2010

(51) Int. Cl. G09F 7/04

(52) U.S. Cl. 40/600

(57) ABSTRACT

A double-sided graphic panel and mechanism to retain and pivot the graphic panel for viewing of either side is disclosed. The double-sided graphic panel is attached to a mounting frame so as to permit the selective display of either side of the graphic panel but so as to retain a connection between the graphic panel and the mounting frame.

This application claims priority under 35 U.S.C. §119 to U.S. Provisional Application No. 60/253,105, which is incorporated herein by reference for all purposes.

### FIELD OF THE INVENTION

The present invention relates generally to the field of advertising. More particularly, the present invention relates to a graphic display system and method to articulate a graphic panel frame to show a second side thereof.

### BACKGROUND

In the field of advertising, there is a need to be able to quickly change a graphic panel for advertising different products within a business day. This is commonly referred to as day parting. This is often a laborious and tedious process, costing businesses time and money. The constraints are cost, physical space and time to change out a graphic. If static graphic panels are used in a single fixed frame, the time to change out the graphics daily becomes an issue, along with physical damage to the graphic panels and storage of the panels when not in use.

Accordingly, there is a need for a graphic panel that can store a second graphic on a second side and a method to articulate the graphic panel frame quickly and easily to show the second side without removing the graphic panels themselves. It would also be desirable to provide a graphic display system and method that includes a frame for supporting the graphic panel frames in an orderly and organized fashion. Additionally, it would be desirable to provide a frame that is configured to be used with other, existing frames in order to create displays comprising a plurality of separate graphic sheets that may be arranged to form a single design and/or graphic.

One known graphic panel design is reflected in U.S. Pat. No. 7,373,747 to Wiemer et al., the disclosure of which is incorporated herein by reference for all purposes. The Wiemer et al. design could be adapted to be used with the present invention to provide a double-sided graphic panel.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### SUMMARY

The present invention relates to a display system with a graphic panel having two support surfaces and two graphic sheets. The graphic sheets each are formed from a substrate having a front surface and a rear surface, wherein a treatment is provided on the front surface and the rear surface. The treatment provided on the front surface of the graphic sheets is a graphic image. The treatment provided to the rear surface of the graphic sheets is a magnetically receptive material. The magnetically receptive material of the graphic sheet is configured to releasably attach through magnetic attraction to the magnetic surfaces of the graphic panel.

The present invention also relates to a display system where the graphic panel may be quickly and easily articulated, allowing either of the two graphic sheets to be displayed without having to remove the graphic sheets from the graphic panel. In one embodiment, the graphic panel is attached to the frame by a ball and socket joint and a second joint consisting of a spring and cylinder are the articulation and retention mechanisms. The ball joint allows the graphic panel to articulate away from the graphic wall, the second joint's spring mechanism allows the graphic panel to translate along a rod, giving clearance so the graphic panel can be rotated about it's vertical axis to show the second side of the graphic panel. In another embodiment, the graphic panel and frame are attached via a self-retracting wire that allows the operator to articulate and rotate the graphic panel, while maintaining the connection between the graphic panel and the frame. In both embodiments, it is advantageous for the graphic panel to remain attached to the frame to help guide the graphic panel into the proper alignment with the frame, as well as preventing both theft of the graphic panel and preventing the graphic panel from falling should the operator mishandle it. Of course, other embodiments could be designed without departing from the invention.

### BRIEF DESCRIPTION OF THE DRAWINGS

FIG. 1 is a perspective view of one embodiment of a double-sided graphic panel in accordance with the invention. A retractable wire is used with the retraction mechanism contained in the graphic panel or in the framework of the sign that allows the panel to be temporarily removed from its location, pivoted, and replaced.

FIG. 2 is a perspective view of the graphic panel of FIG. 1 showing the graphic panel releasing from the framework of the sign in the direction indicated by the arrow but being retained by a retractable wire.

FIG. 3 is a perspective view of the graphic panel of FIG. 1 showing the graphic panel rotating around the retractable wire so as to allow the second side of the graphic panel to be displayed.

FIG. 4 is a perspective view of the graphic panel of FIG. 1 showing the graphic panel being re-inserted into the framework of the sign in the direction indicated by the arrow.

FIG. 5 is a perspective view of the graphic panel of FIG. 1 showing a detail of the attachment of the wire from a retractable wire mechanism located in the graphic panel to a crossbar member located in the framework of the sign.

FIG. 6 is a perspective view of one alternative embodiment of a double-sided graphic panel in accordance with the invention. A ball and socket joint and a second joint comprising a spring and cylinder are the articulation and retention mechanisms.

FIG. 7 is a perspective view of the embodiment of FIG. 6 showing how the ball and socket joint allows the graphic panel to articulate outward from the framework of the sign in the direction indicated by the arrow.

FIG. 8 is a perspective view of the embodiment of FIG. 6 showing how the graphic panel travels along the cylinder while compressing the spring.

FIG. 9 is a perspective view of the embodiment of FIG. 6 showing the rotation of the graphic panel around the spring and cylinder.

FIG. 10 is a perspective view of a single graphic panel used in the present invention showing a graphic sheet.

### DETAILED DESCRIPTION

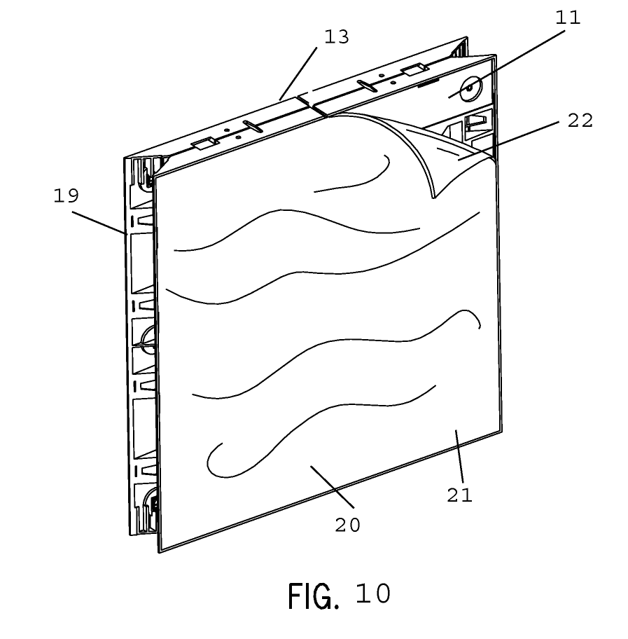

Referring to FIG. 10, a perspective view of a graphic panel 19 in accordance with the invention is shown. The graphic panel 19 has two surfaces 11, 13 both of which are magnetic. A graphic sheet 20 may be magnetically aligned and attached to either surface 11, 13 of the graphic panel 19. The graphic sheet 20 has two sides 21, 22. The first side 21 of the graphic sheet 20 is a printed graphic. The second side 22 of the graphic sheet 20 is a magnetically receptive material that magnetically attaches to either surface 11, 13 of the graphic panel 19. Alternatively, the magnetic and magnetically receptive materials may be reversed.

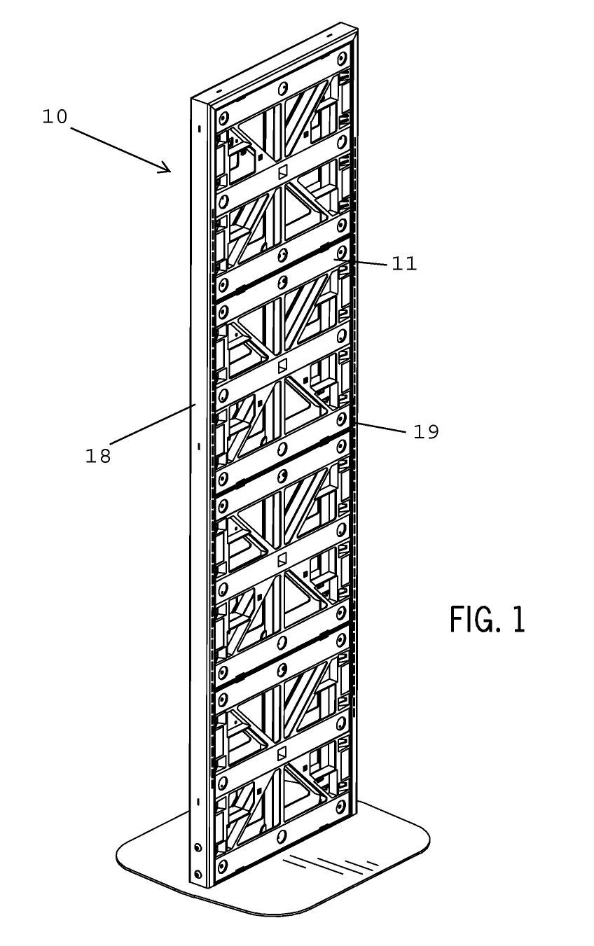

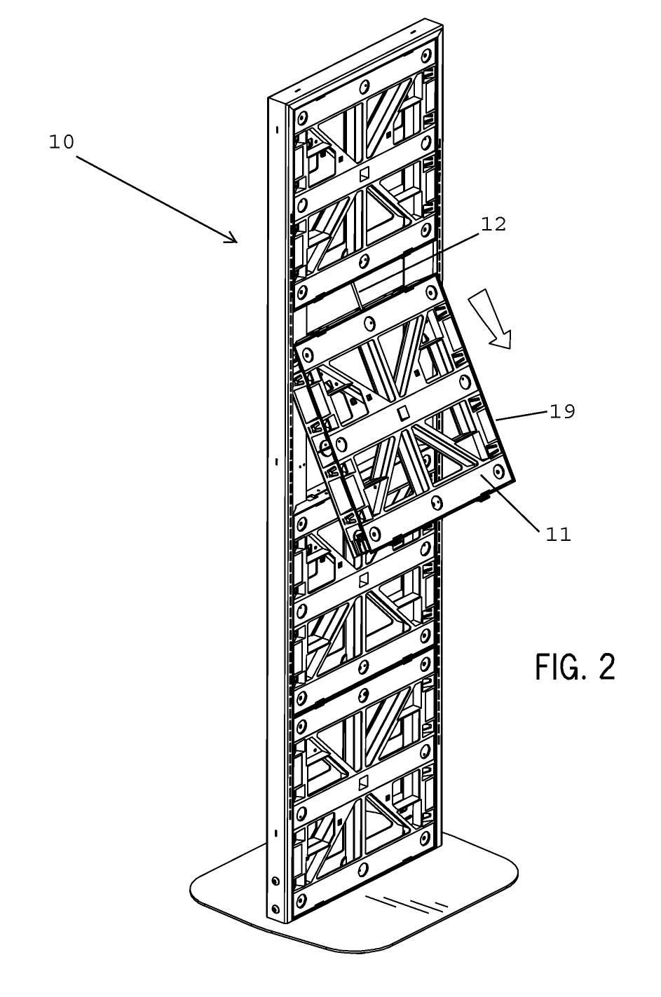

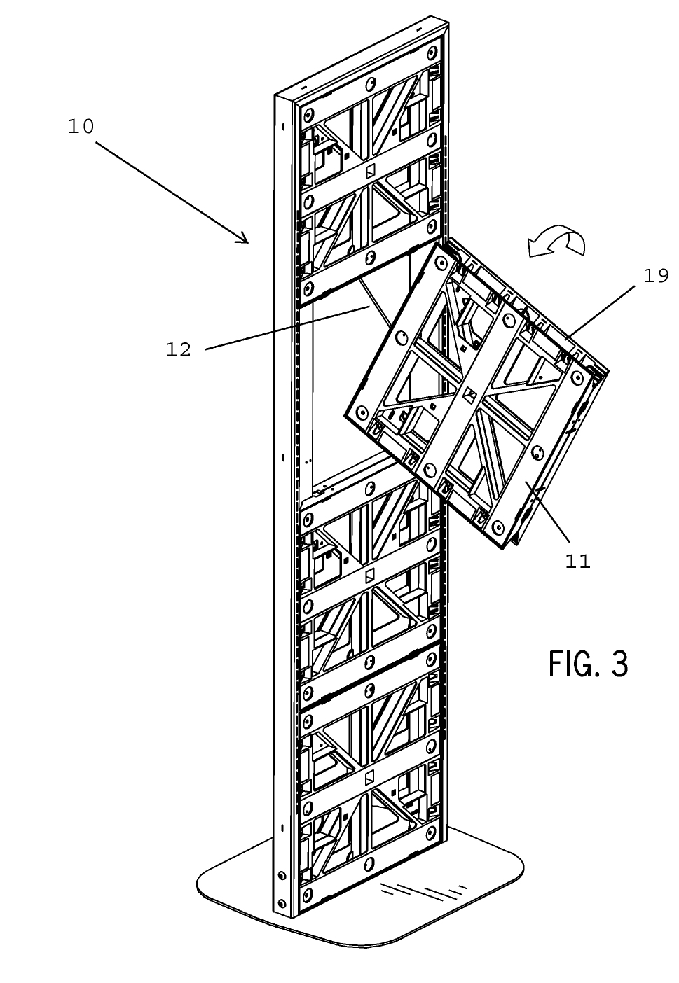

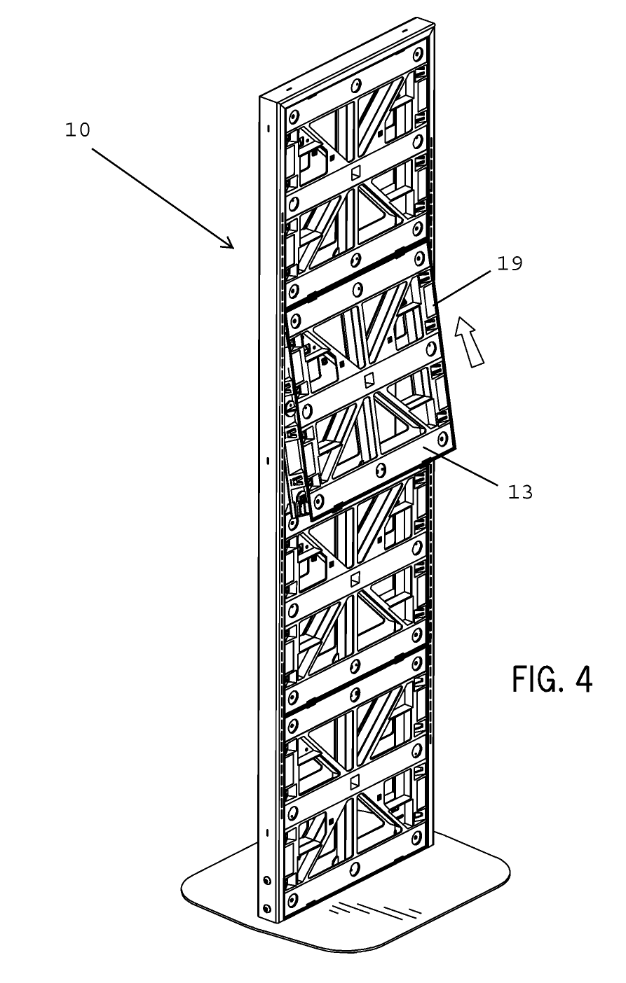

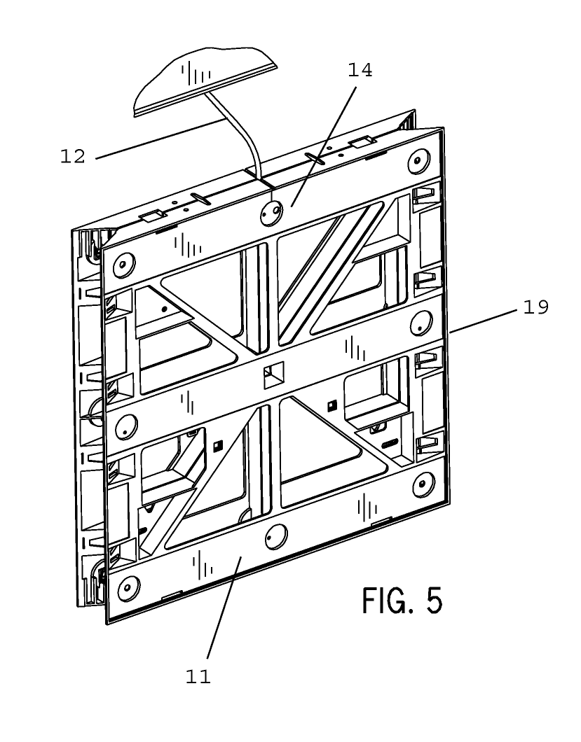

Referring to FIGS. 1 through 5, a perspective view of one embodiment of the double-sided graphic panel assembly 10 in accordance with the invention is shown. A retractable wire 12 is used with a retraction mechanism 14 contained in the graphic panel or in the framework 18 of the sign that allows the panel 19 to be removed from it's location. Any reel type or other retraction mechanism may be used. The graphic panel 19 may be located within a matrix of graphic panels 10 or be a single panel display. FIGS. 2 through 4 show the process of articulating and rotating the graphic panel 19. In FIG. 2, the first side 11 of the graphic panel 19 is visible and the graphic panel 19 has been articulated out from its original position in the framework 18 of the sign. FIG. 3 shows the rotation of the graphic panel 19 around its vertical axis. FIG. 4 shows the re-insertion of the graphic panel 19 into the framework 18 of the sign, where now the second side 13 of the graphic panel 19 is visible. FIG. 5 shows additional detail of one particular embodiment of the invention where the retention wire 12 and retraction mechanism 14 are located in the graphic panel 19. Alternative embodiments could locate the refraction mechanism 14 in the framework 18 and/or could locate the connection on the side or bottom of the graphic panel 19.

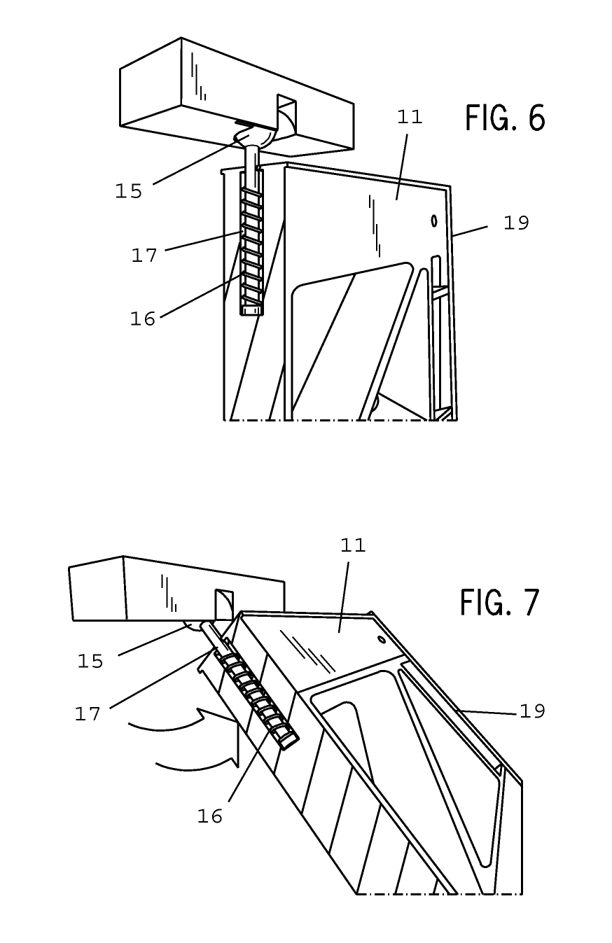

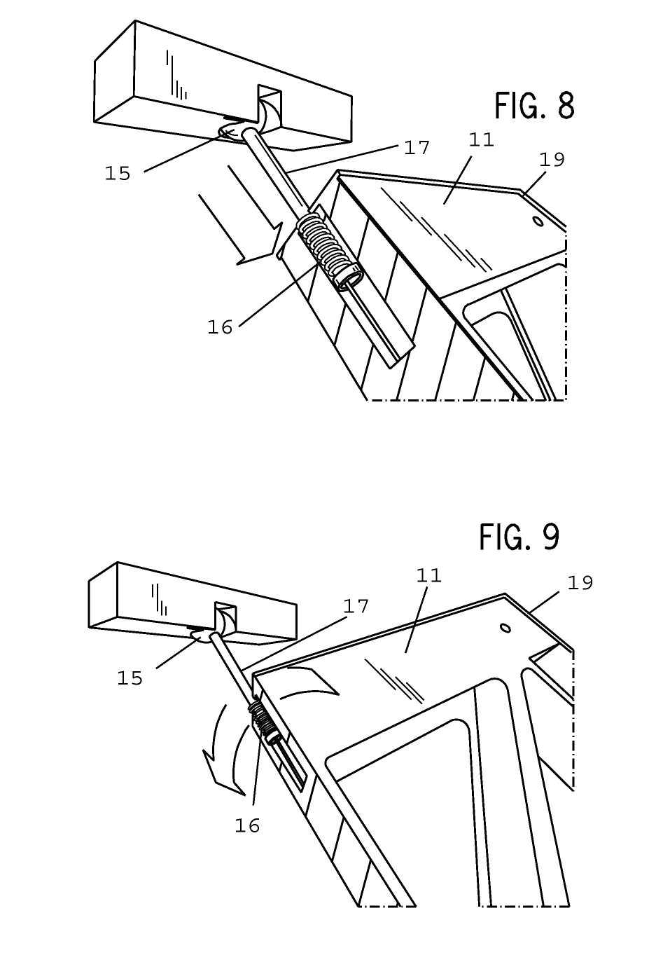

Referring now to FIGS. 6 through 9, a perspective view of another embodiment of a double-sided graphic panel 19 in accordance with the invention is shown. A ball and socket joint 15 and a second joint including a spring 16 and cylinder 17 are the articulation and retention mechanisms. The ball joint 15 allows the graphic panel to articulate away from the framework 18 of the sign, the second joint's spring mechanism 16 allows the graphic panel to translate along a cylinder 17, giving clearance so the graphic panel 19 can be rotated about it's vertical axis to show the second side 13 of the graphic panel.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A display comprising:
a panel mounting member having a first mounting side and a second mounting side, the mounting sides each having a magnetic surface and adapted to receive graphic sheets, the graphic sheets having first and second sides, the first side comprising a printed graphic, the second side comprising a magnetically receptive material; and
a panel mounting frame, the panel mounting member attached to but pivotably displaceable from the panel mounting frame so as to permit the display of either the first mounting side of the panel mounting member or the second mounting side of the panel mounting member.

2. The display of claim 1, wherein the panel mounting member is attached to the panel mounting frame by a ball and socket joint connected to a cylinder, the cylinder passing through a spring.

3. The display of claim 2, wherein the cylinder and spring allow the panel mounting member to rotate freely around the cylinder when the panel mounting member is displaced from the panel mounting frame.

4. The display of claim 2, wherein the cylinder and spring are configured to provide sufficient force to prevent the panel mounting member from falling out of the panel mounting frame when the panel mounting member is not displaced therefrom.

5. The display of claim 1, wherein the panel mounting member is attached to the panel mounting frame by a flexible tether.

6. The display of claim 5, wherein the flexible tether is connected to a self-winding spool, the self-winding spool attached to the panel mounting member.

7. The display of claim 5, wherein the flexible tether is connected to a self-winding spool, the self-winding spool incorporated into the panel mounting member.

8. The display of claim 1, wherein the panel mounting member is aligned to the panel mounting frame by magnetic force.

9. The display of claim 1, wherein the magnetic surface comprises a plurality of magnetic strips adhered to the panel mounting member.

10. The display of claim 1, wherein a plurality of panel mounting frames are configured to form an overall composite design.

11. A display comprising:
a panel mounting member having a first mounting side and a second mounting side, the mounting sides each having a magnetically receptive surface and adapted to receive graphic sheets, the graphic sheets having first and second sides, the first side comprising a printed graphic, the second side comprising a magnetic material; and
a panel mounting frame, the panel mounting member attached to but pivotably displaceable from the panel mounting frame so as to permit the display of either the first mounting side of the panel mounting member or the second mounting side of the panel mounting member.
